(19) United States
(12) Patent Application Publication
(10) Pub. No.: US 2005/0157604 A1
(43) Pub. Date: Jul. 21, 2005

(54) Method of storing calibration data in a circuit board and an optical disc drive thereof

(75) Inventors: Cheng-Fu Lee, Taipei (TW); Ming-Hsing Lu, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/036,077

(22) Filed: Jan. 18, 2005

(30) Foreign Application Priority Data
Jan. 20, 2004 (TW) 93101682

(51) Int. Cl. G11B 7/085

(52) U.S. Cl. 369/30.27; 369/53.26

(57) ABSTRACT

An optical disc drive for accessing an optical disc is provided. The optical disc drive includes an optical/mechanical assembly (OMA) and a special pattern board having an in-built calibration data of the OMA, wherein the special pattern board is disposed in the OMA.

This application claims the benefit of Taiwan application Serial No. 93101682, filed Jan. 20, 2004, the subject matter of which is incorporated herein by reference.

### BACKGROUND OF THE INVENTION

1. Field of the Invention

The invention relates in general to an optical disc drive, and more particularly to an optical disc drive used in a digital versatile disc player (DVD Player).

2. Description of the Related Art

More and more DVD players are equipped with writing function. A DVD player with writing function is generally called “DVD Recordable Player”.

An optical disc drive with reading/writing abilities is the main part of a DVD recordable player. An optical disc drive includes two parts: an optical/mechanical assembly (OMA) and a control circuit board. To assure the writing quality of optical discs of varied makes and qualities, a set of calibration data of laser power emitted by an optical pick-up head of the OMA are normally stored in the control circuit board, wherein the control circuit board is incorporated with the OMA.

When the OMA is writing an optical disc, which can be of varied qualities, the control circuit board will activate the optical pick-up head of the OMA to emit calibrated laser beam to write the optical disc according to the set of calibration data of laser power.

Referring to FIG. 1, a flowchart of storing calibration data of laser power in a control circuit board according to a conventional method. The steps of the method are disclosed below. Step 110: storing the calibration data of laser power of an OMA in a control circuit board. Step 120: enabling the OMA to be electrically connected with the control circuit board and assembling the two parts to form an optical disc drive.

Step 130: measuring the power of the laser beam emitted by the optical pick-up head of the OMA. Step 140: calibrating the power of the laser beam to obtain calibration data of laser power. Step 150: storing the calibration data of laser power in the control circuit board. Step 160: terminating the method of storing the calibration data of laser power of the OMA in the control circuit board.

According to the conventional method of storing calibration data of laser power in the control circuit board disclosed above, calibration data of laser power are normally stored in the control circuit board after the assembly of the OMA and the control circuit board is completed.

Since each optical disc drive (the assembly of an OMA and a control circuit board) has individual calibration data of laser power, the calibration data of laser power of each optical disc drive need to be measured and inputted to the optical disc drive to be stored in the control circuit board.

Considering the convenience and saving in delivery, the OMA and the control circuit board are normally packed and delivered to customers in separate packages. Due to the lack of suitable equipment to measure the calibration data of laser power, the customers are unable to acquire the calibration data of laser power according to the above-disclosed method.

### SUMMARY OF THE INVENTION

It is therefore an object of the invention to provide a method of storing calibration data of laser power in a control circuit board and the optical disc drive thereof, which, prior to the assembly of the OMA and the control circuit board, stores the calibration data of laser power emitted by an optical pick-up head of an optical/mechanical assembly (OMA) in a control circuit board, which controls the operation of the OMA.

According to the above-identified object, the invention provides an optical disc drive for accessing an optical disc. The optical disc drive includes an OMA and a special pattern board. The OMA includes an accessing element, an optical pick-up head, which accesses an optical disc by emitting a laser beam, for instance. The special pattern board, which is disposed on the OMA, has an in-built calibration data of the laser power emitted by the optical pick-up head.

The optical disc drive disclosed above further includes a control element such as a control circuit board. The control circuit board is for reading and storing the in-built calibration data of laser power of the special pattern board. Moreover, the control circuit board is electrically connected with the OMA, wherein the control circuit board can activate the optical pick-up head to emit a calibrated laser beam according to the calibration data of laser power stored therein.

According to the above-identified object, the invention provides a method of storing calibration data of laser power in a control circuit board. The steps of the method are disclosed below. Firstly, measure the power of a laser beam emitted by an accessing element of an OMA. Secondly, calibrate the power of the laser beam to obtain calibration data of laser power. Thirdly, have the in-built calibration data of a special pattern board disposed on the OMA. Lastly, read the in-built calibration data of laser power of the special pattern board and store the calibration data of laser power in a control circuit board.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a flowchart of storing calibration data of laser power in a control circuit board according to a conventional method;

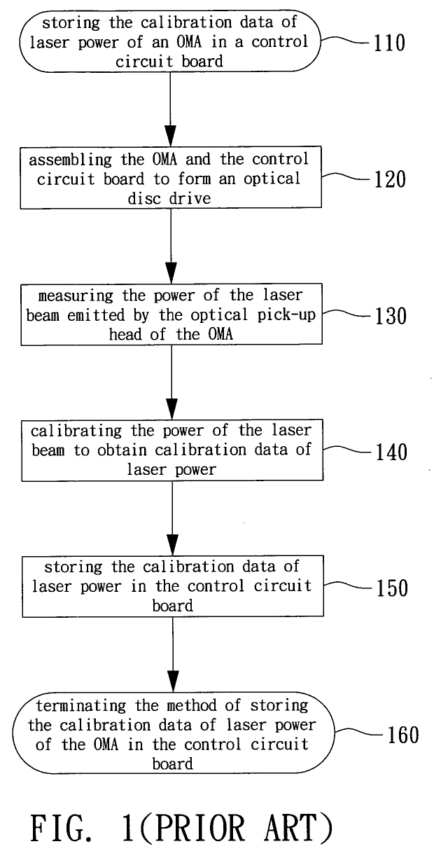

FIG. 2 is a three-dimensional diagram of an optical disc drive according to a preferred embodiment of the invention;

FIG. 3 is a top view and a side view of the optical/mechanical assembly in FIG. 2 equipped with a special pattern board;

FIG. 4 is a flowchart of storing calibration data of laser power in a control circuit board according to the invention; and

FIG. 5 is a flowchart of storing optical characteristics calibration data of laser power in a control circuit board according to the invention.

### DETAILED DESCRIPTION OF THE INVENTION

The invention is disclosed in a preferred embodiment. However, the preferred embodiment will not limit the scope of protection of the invention. The preferred embodiment discloses a method and an optical disc drive of storing calibration data of laser power in a control circuit board according to the spirit of the invention. The technical characteristics of the invention are disclosed below.

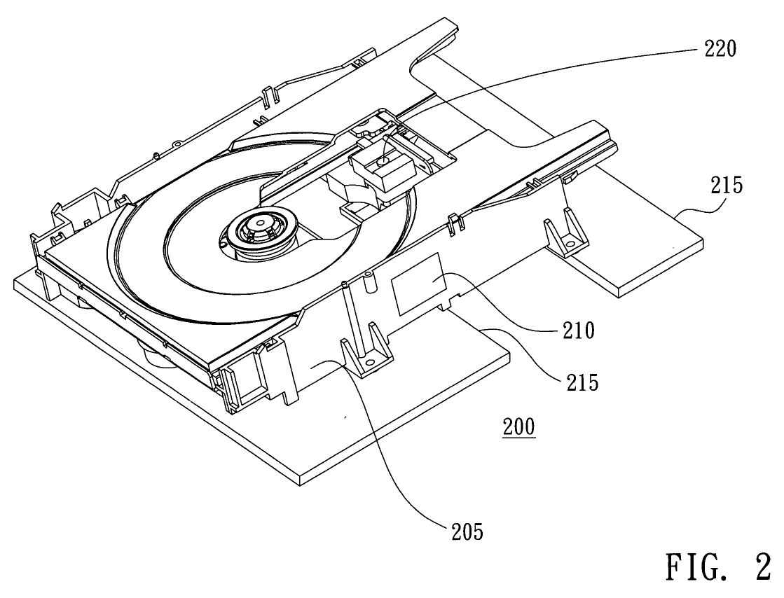

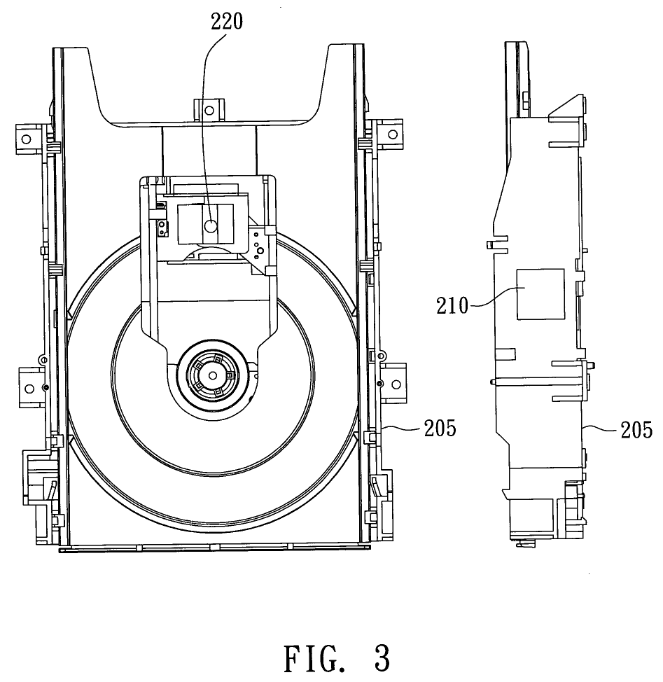

Please refer to FIG. 2 and FIG. 3 at the same time. FIG. 2 is a three-dimensional diagram of an optical disc drive according to a preferred embodiment of the invention, while FIG. 3 is a top view and a side view of the optical/mechanical assembly in FIG. 2 equipped with a special pattern board. According to the invention, an optical disc drive 200, which can be used in a DVD recordable player, is for accessing an optical disc. The optical disc drive 200 includes an optical/mechanical assembly (OMA) 205, a special pattern board 210 and a control element such as control circuit board 215. The OMA 205 has an access element such as an optical pick-up head 220. The optical disc drive 200 accesses the optical disc by emitting a laser beam.

It is noteworthy that FIG. 2 shows a scenario when the OMA 205 and the control circuit board 215 are separate. Considering the OMA 205 and the control circuit board 215 are normally delivered to the customer in separate packages to be assembled by the customer, the calibration data of the laser power emitted by the optical pick-up head 220 are built in the special pattern board 210 in advance.

Prior to the assembly of the OMA 205 and the control circuit board 215, the special pattern board 210 with an in-built calibration data of laser power is disposed on the OMA 205 in advance. For example, the special pattern in the special pattern board 210 can be a bar-code pattern.

After delivery, the OMA 205 and the control circuit board 215 will then be assembled and electrically connected together to form the optical disc drive 200.

Meanwhile, the control circuit board 215 can be used to read and store the in-built calibration data of laser power of the special pattern board 210. Furthermore, the control circuit board 215 will activate the optical pick-up head 220 to emit a calibrated laser beam according to the calibration data of laser power stored in the special pattern board 210.

According to the preferred embodiment disclosed above, the OMA 205 and the control circuit board 215 can be delivered to the customer in separate package and assembled afterwards. By means of a simple bar-code reading facility, the in-built calibration data of the laser power of the special pattern board 210 can be accessed and inputted into the control circuit board 215, so that the control circuit board 215 can control the OMA 205 accordingly.

The special pattern board 210 disclosed in the above preferred embodiment can be disposed on the OMA 205 at wherever convenient for a facility to read the special pattern board 210. For example, the special pattern board 210 in FIG. 2 is adhered onto a lateral side of the OMA 205.

Moreover, the special pattern board 210 does not necessarily to be disposed on the OMA 205. The special pattern board 210 can be delivered to the customer either along with the OMA 205 or along with the control circuit board 215, so that the customer can conveniently access the calibration data of laser power stored in the special pattern board 210.

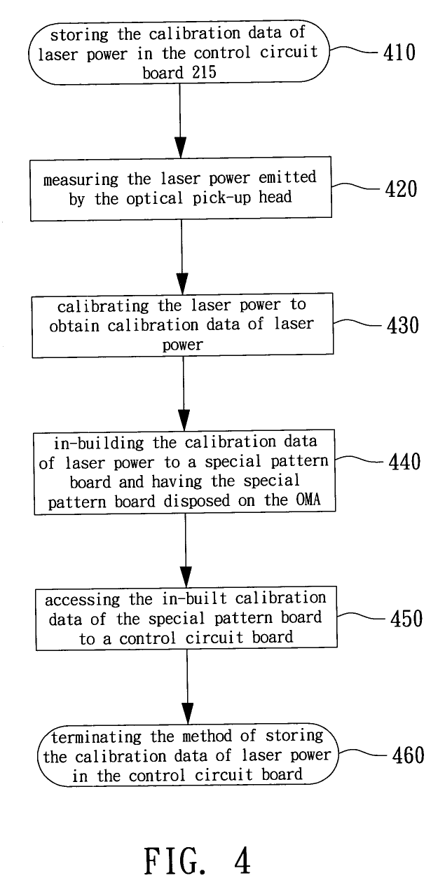

A method is disclosed below to further elaborate the application and the spirit of the invention. Please refer to both FIG. 2 and FIG. 4. FIG. 4 is a flowchart of storing calibration data of laser power in a control circuit board according to the invention. FIG. 4 includes the following steps. Step 410: storing the calibration data of laser power of the OMA 205 in the control circuit board 215. Step 420: measuring the laser power emitted by the optical pick-up head 220 of the OMA 205.

Step 430: calibrating the laser power to obtain calibration data of laser power. Step 440: in-building the calibration data of laser power to the special pattern board 210 and having the special pattern board 210 disposed on the OMA 205.

Step 450: assembling the OMA 205 and the control circuit board 215 together or enabling the OMA 205 to be electrically connected with the control circuit board 215, furthermore, accessing and storing the in-built calibration data of laser power of the special pattern board 210 in the control circuit board 215. Step 460: terminating the method of storing the calibration data of laser power of the OMA 205 in the control circuit board 215.

The special pattern board 210 of the optical disc drive 200 disclosed above can have in-built data such as calibration data of laser power of the optical pick-up head 220 or any other optical characteristics calibration data of the OMA 205.

The OMA 205 and the control circuit board 215 can be delivered to the customer in separate packages; then the customer can use the control circuit board 215 to access the in-built calibration data of laser power of the special pattern board 210 such as optical characteristics calibration data.

After the control circuit board 215 is electrically with the OMA 205, according to the stored optical characteristics calibration data, the control circuit board 215 can activate the OMA 205 to function.

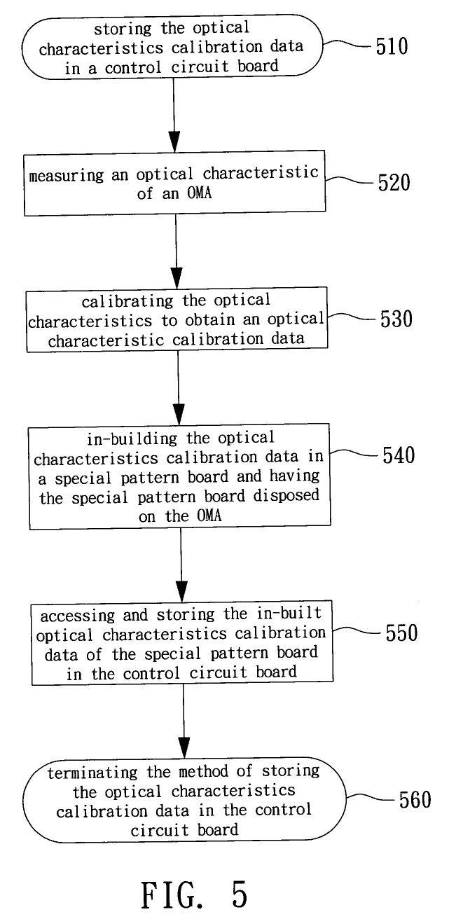

With regard to the storing method corresponding to the optical disc drive, please refer to FIG. 2 and FIG. 5 at the same time. FIG. 5 is a flowchart of storing optical characteristics calibration data of laser power in a control circuit board according to the invention. The steps of the method are disclosed below. Step 510: storing the optical characteristics calibration data of the OMA 205 in the control circuit board 215. Step 520: measuring an optical characteristic of the OMA 205.

Step 530: calibrating the optical characteristics to obtain an optical characteristic calibration data. Step 540: in-building the optical characteristics calibration data in the special pattern board 210 and having the special pattern board 210 disposed on the OMA 205 accordingly.

Step 550: assembling the OMA 205 and the control circuit board 215 together or enabling the OMA 205 to be electrically connected with the control circuit board 215, furthermore, accessing and storing the in-built optical characteristics calibration data of the special pattern board 210 in the control circuit board 215. Step 560: terminating the method of storing the optical characteristics calibration data of the OMA 205 in the control circuit board 215.

The features and advantages of the above-mentioned method of storing calibrated data in a control circuit board and the optical disc drive thereof are summarized below. The OMA and the control circuit board can be delivered to the customer in separate packages and assembled afterwards; furthermore, the calibration data of laser power of the optical pick-up head can be measured and stored in the control circuit board by means of simple procedures and equipment. Consequently the OMA and the control circuit board can be more conveniently delivered to the customer in separate packages, leading to a large saving in delivery costs.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An optical disc drive for accessing an optical disc, wherein the optical disc drive comprise:
an optical/mechanical assembly (OMA); and
a special pattern board having an in-built optical characteristics calibration data of the OMA, wherein the special pattern board is disposed in the OMA.

2. The optical disc drive according to claim 1, wherein the optical disc drive further comprises a control element for accessing and storing the in-built optical characteristics data of the special pattern board.

3. The optical disc drive according to claim 2, wherein the control element is electrically connected with the OMA, according to the optical characteristics calibration data the control element can activate the OMA to function.

4. The optical disc drive according to claim 2, wherein the control element is a control circuit board.

5. A method of storing optical characteristics calibration data in a control circuit board, comprising the steps of:
measuring an optical characteristic of an OMA;
calibrating the optical characteristics to obtain an optical characteristic calibration data;
in-building the optical characteristics calibration data in a special pattern board and having the special pattern board disposed on the OMA; and
accessing the in-built optical characteristics calibration data and storing the in-built optical characteristics calibration data in a control circuit board.

6. A method of storing optical characteristics calibration data in a control circuit board, comprising the steps of:
measuring an laser power emitted from an access element of an OMA;
calibrating the laser power to obtain an calibration data of laser power;
in-building the calibration data of laser power in a special pattern board and having the special pattern board disposed on the OMA; and
accessing the in-built calibration data of laser power and storing the in-built calibration data of laser power in a control circuit board.
